(19) United States
(12) Patent Application Publication
(10) Pub. No.: US 2014/0078888 A1
(43) Pub. Date: Mar. 20, 2014

(54) PROCEDURE, APPARATUS, SYSTEM, AND COMPUTER PROGRAM FOR DESIGNING A VIRTUAL PRIVATE NETWORK

(71) Applicants: David William Jenkins, North Aurora, IL (US); Ramasubramanian Anand, Plainfield, IL (US); Kenneth Martin Fisher, Aurora, IL (US)

(72) Inventors: David William Jenkins, North Aurora, IL (US); Ramasubramanian Anand, Plainfield, IL (US); Kenneth Martin Fisher, Aurora, IL (US)

(73) Assignee: TELLABS OPERATIONS INC., Naperville, IL (US)

(21) Appl. No.: 13/618,758

(22) Filed: Sep. 14, 2012

(51) Int. Cl. H04L 12/24; H04L 12/28

(52) U.S. Cl. 370/221; 370/255; 370/228

(57) ABSTRACT

A procedure for designing a virtual private network, and a system, apparatus, and computer program that operate in accordance with the procedure. The procedure includes receiving at least one of network information, a bandwidth objective and a protection objective. A mesh algorithm is executed based on the at least one of the network information, the bandwidth objective and the protection objective, to generate one or more mesh algorithm results.

### BACKGROUND

1. Field

Example aspects described herein relate generally to network design, and more particularly, to procedures, apparatuses, systems, and computer programs for designing a virtual private network (VPN) that accommodates predetermined requirements of bandwidth allocation and protection for various types of optical network traffic.

2. Description of Related Art

Communication service providers utilize networks that communicate information from one customer location to another in a variety of ways. There are many types of communication network traffic, including, for example, voice traffic, internet traffic and storage area networking (SAN) traffic. Networks provide transport for traffic from a source to a destination by connecting the traffic by way of switching elements appropriate for the type of traffic. Increasingly, the switching is being done through the Internet Protocol (IP), which can be tailored to the many offerings of the service provider. The IP network resides in the switching layers, sometimes referred to as layer 3 of the Open Systems Interconnection (OSI) model. The transport of the traffic resides in layers 1 and 2 of the OSI model.

One type of IP service offering is a virtual private network that provides a communication connection between multiple customer sites. A virtual private network can be ideal for a large corporation or another large widely dispersed organization. Since different customers have different service requirements, the services offered by the service provider can have different capabilities to meet these requirements and the services can be sold under varying service level agreements (SLA) that specify these capabilities and/or requirements. Virtual private networks can span large distances so often an underlying optical or dense wavelength division multiplexed (DWDM) based network is used to span such large distances.

One requirement of many customers includes varying levels of availability, which is defined as the fraction of time the service is working properly. For example, an availability of 99.9999%, which is sometimes referred to as “six nines availability”, is sometimes the required availability for voice traffic. This is to ensure that emergency calls (e.g., 911 calls) will be successfully communicated with a sufficient degree of certainty. Another way to state six nines availability is to state that the traffic is down (i.e., not functioning properly) only 0.000001*365 days or 5.25 minutes per year.

While affordable equipment often cannot provide a six nines level of availability, service providers can greatly improve the availability of their services if they provide multiple transport paths for traffic so that, in the event an actively working path carrying traffic fails, then the traffic can be rerouted to one or more other protection paths to carry the load.

For some types of traffic, for example voice traffic, the traffic may be required to switch to a secondary path quickly (e.g., within 50 milliseconds) so the phone call will not be dropped. If a fault lasts too long (e.g., longer than 50 milliseconds) then the call may be dropped. Therefore, voice traffic usually requires fast switching (e.g., active) protection paths. Other types of traffic, for example common Internet traffic such as web surfing, may not require quick switching and the internet traffic has internal mechanisms to resend the traffic along different paths but these mechanisms are much slower than the 50 millisecond requirement for voice.

So, depending on the requirements of a customer, a virtual private network can require fast active transport switching, or slower restorative transport switching or no switching in the transport layer at all. Many customers will use all three cases.

To satisfy these types of customer requirements a service provider may need to allocate bandwidth among a variety of sites with varying levels of protection over an optical network. Conventional approaches include providing many high bandwidth communication paths between each of the sites so that any one path can support all of the traffic. However, this is an expensive solution since it requires many large bandwidth connections to IP routers. Connections to IP routers are typically much more expensive than the same bandwidth size connection on transport equipment.

Additionally, many large service providers include separate organizations that may operate the IP layer and the transport layer, respectively, and these two organizations often utilize different tools for network design.

### SUMMARY

Existing limitations associated with the foregoing, as well as other limitations, can be overcome by a procedure for designing a virtual private network, and by an apparatus, system, and computer program that operate in accordance with the procedure. In accordance with some aspects described herein, a cost effective solution is provided for protecting virtual private network services in the transport layer of the network.

In one example embodiment herein, the procedure includes receiving at least one of network information, a bandwidth objective and a protection objective. A mesh algorithm is executed based on the at least one of the network information, the bandwidth objective and the protection objective, to generate one or more mesh algorithm results. The one or more mesh algorithm results can be provided via a user interface, according to one example.

The network information can include, in another example, at least one of a topology of the network, a geographical location of a node, a geographical location of a link, a length of a link, a statistical availability of a link, a statistical availability of a node, a type of optical fiber used for a link, an optical signal to noise ratio (OSNR), an optical loss of a link, an optical loss of a node, a polarization mode dispersion number of a link, a polarization mode dispersion number of a node, a node component, and a node routing capability of a node.

According to another example embodiment, the bandwidth objective can indicate an amount of bandwidth required for a predetermined type of traffic between nodes.

In a further example, the protection objective can indicate, for a predetermined type of traffic between nodes, at least one of a number of mesh paths required and a type of one or more mesh paths.

The procedure also can include executing a simulation of at least one of a link failure and a node failure, to generate one or more simulation results. In one example, the one or more simulation results can be provided via a user interface. The link failure can include, for example, at least one of a partial failure of a link and a complete failure of a link, and the node failure includes at least one of a partial failure of a node and a complete failure of a node.

Further in accordance with an example embodiment herein, the procedure includes identifying additional network equipment required based on the at least one of the network information, the bandwidth objective and the protection objective.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, wherein:

FIG. 1 is a representation of an example communication network that is constructed and operated in accordance with at least one example aspect herein.

FIG. 2 is another representation of an example communication network that is constructed and operated in accordance with at least one example aspect herein.

FIG. 3 is still another representation of an example communication network that is constructed and operated in accordance with at least one example aspect herein.

FIG. 4 is an architecture diagram of a processing system in accordance with an example embodiment described herein.

FIG. 5 is an example flow diagram that illustrates a procedure for designing a network, in accordance with an example embodiment described herein.

FIG. 6 is an example flow diagram that illustrates a procedure for simulating the failure of one or more links and/or nodes, in accordance with an example embodiment described herein.

### DETAILED DESCRIPTION

Presented herein are a novel and inventive procedure, and also a system, apparatus, and computer program that operate in accordance with the procedure, for designing a network such as, by example only, a virtual private network. The term “sub-network” or “sub-net”, as used herein, generally refers to a network within a network. For example, where one or more Internet Protocol (IP) networks communicate signals to one or more destinations by way of an underlying optical transport network, the one or more IP networks can be considered sub-nets of the optical transport network. In one example, the virtual private network(s) designed in accordance with the procedure(s) described herein can include an underlying optical network that provides connectivity between multiple sub-nets, such as sub-nets of multiple office locations of a corporate customer.

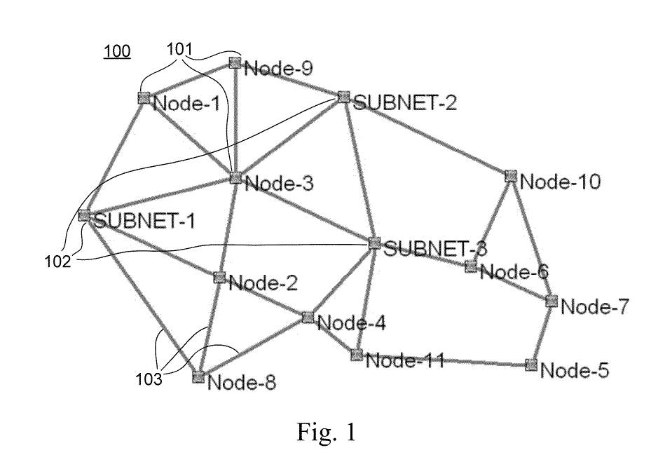

FIG. 1 is a representation of an example communication network 100 that is constructed and operated in accordance with at least one example aspect herein. In particular, the network 100 illustrated in FIG. 1 represents an example virtual private network that can be designed in accordance with the procedure, apparatus, system, and computer program described herein, as will be described in further detail in connection with the below example embodiments. In one example embodiment, the network 100 represents an optical transport network or a mesh network, including a virtual private network, although the network 100 can also represent other types of networks.

The network 100 includes a plurality of nodes 101 each representing one or more optical signal transmitters, receivers, and/or transceivers that transmit and/or receive optical signals. Although not shown in FIG. 1 for purposes of convenience, each transmitter, receiver, and/or transceiver corresponding to a node can also include additional equipment (which can be optical, electrical, and/or opto-electrical), such as, by example only, one or more multiplexers, routers, switches, wavelength selective switches, amplifiers, filters, processors, waveguides, reconfigurable optical add/drop multiplexers (ROADMs), opto-electrical converters, and/or the like. In one example, each node 101 can represent one or more transceivers installed in a particular geographical location.

Each of the nodes 101 is communicatively coupled to one or more of the other nodes 101 via one or more links 103. The term “link”, as used herein, refers to a communicative coupling between two adjacent nodes, by which the transceivers of the two nodes can transmit and/or receive one or more signals to each other. The term “path”, as used herein, can include one or more links. In one example embodiment, each link 103 is constructed of one or more optical fibers able to carry dense wavelength division multiplexed (DWDM) optical signals thereon, but this example should not be construed as limiting. In other example embodiments, each link 103 can represent a wireless communicative coupling or a wired communicative coupling, and the signals communicated through the network 100 can include optical signals, electrical signals, and/or electromagnetic signals.

Also included in the network 100 are three nodes 102 designated SUBNET-1, SUBNET-2, and SUBNET-3, respectively, which, according to one example embodiment, represent three sub-nets that collectively form a virtual private network. That is, although each of the nodes 102 designated SUBNET-1, SUBNET-2, and SUBNET-3 is depicted in FIG. 1 as being a single node for purposes of convenience, each of the nodes 102 designated SUBNET-1, SUBNET-2, and SUBNET-3 represents an underlying sub-network which may include multiple nodes. According to one example, each of the three nodes 102 designated SUBNET-1, SUBNET-2, and SUBNET-3 represents a sub-net including at least one transceiver installed in a corresponding one of three locations of a company, and the virtual private network communicatively couples the three locations of the company.

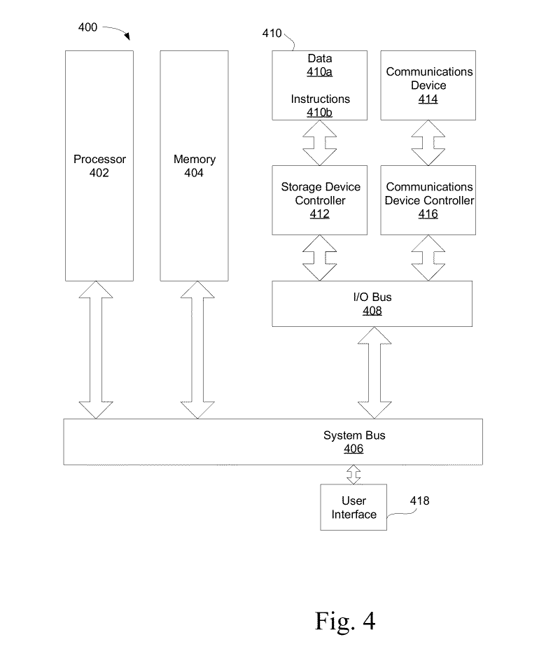

Each of the nodes 101 and 102 of the network 100 is communicatively coupled to one or more other ones of the nodes 101 and 102 of the network 100 via one or more paths, each path being made up of at least one of the links 103. In this way, each of the nodes 101 and/or 102 can transmit one or more signals to, and/or receive one or more signals from, other nodes via the links 103. As will be described in further detail below with respect to FIG. 4, in accordance with the various example aspects described herein, the routes by which one or more signals are communicated from any one node 101 or 102 to any other node 101 or 102 can be configured in order for the network 100 to provide a predetermined level of performance and/or reliability.

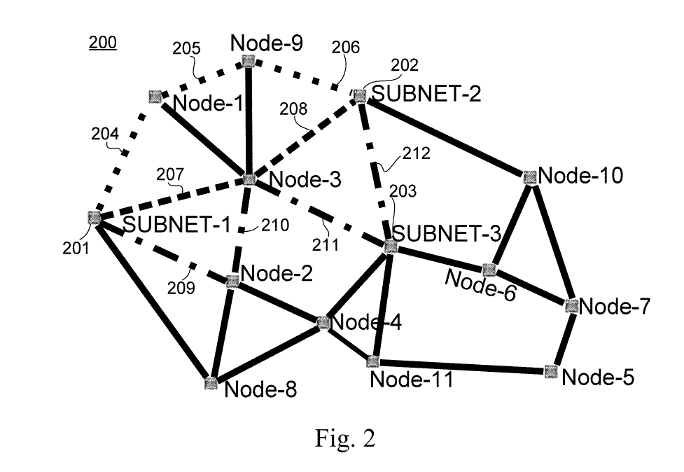

Referring now to FIG. 2, another representation of an example communication network 200 including a virtual private network will now be described, in accordance with at least one example aspect herein. In particular, the network 200 illustrated in FIG. 2 represents an example virtual private network that can be designed in accordance with the procedure, the apparatus, system, and computer program described herein, as will be described in further detail in connection with the below example embodiments. In one example embodiment the network 200 represents an optical transport network or mesh network, although the network 200 also can represent other types of networks.

The network 200 illustrated in FIG. 2 has a similar topology to the network 100 described above in connection with FIG. 1, but for purposes of illustration certain links of the network 200 have been drawn using different line patterns in order to illustrate a network protection design technique relating to link diverse paths. Paths in a network are link diverse paths if the paths do not share any common links. In designing a network, providing link diverse paths between nodes provides a measure of protection in that, if any one link fails for some reason (e.g., a communication line is physically severed, a particular node becomes congested with data, etc.), then a path that is link diverse with respect to the failed path can remain unaffected and can be used in place of the path that includes the failed link. If, on the other hand, two particular nodes are not communicatively coupled via a plurality of link diverse paths and one link fails, the nodes can become rendered incapable of communicating signals to or from each other.

In FIG. 2, sub-net nodes 201, 202, and 203 (which, according to one example embodiment are part of a virtual private network) are communicatively coupled via at least three link diverse paths. For example, node 201 is connected to node 202 via three link diverse paths, namely, a first path made up of links 204, 205 and 206; a second path made up of links 207 and 208; and a third path made up of links 209, 210, 211, and 212. In this way, if, for example, link 204 fails for some reason, then the first path is affected (i.e., non-operational), but the second and third paths remain unaffected (i.e., operational).

As also will be described below in further detail in connection with the below example embodiments, the procedure, the apparatus, system, and computer program described herein can be used to design a virtual private network having a plurality of link diverse paths, in accordance with some example embodiments.

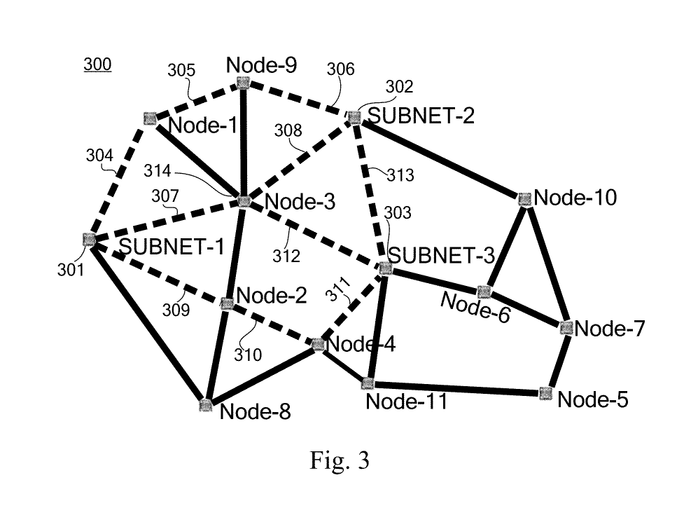

Referring now to FIG. 3, another representation of an example communication network 300 including a virtual private network will now be described, in accordance with at least one example aspect herein. In particular, the network 300 illustrated in FIG. 3 represents an example virtual private network that can be designed in accordance with the procedure, apparatus, system, and computer program described herein, as will be described in further detail in connection with the below example embodiments.

The network 300 illustrated in FIG. 3 has a similar topology to the networks 100 and 200 described above in connection with FIGS. 1 and 2, respectively, but for purposes of illustration certain links of the network 300 have been drawn using different line patterns in order to illustrate a network design technique relating to node diverse paths. Node diverse paths, like link diverse paths (described above), can be used to provide a measure of protection in the event of a failure of one or more links or nodes in a network. Paths in a network are node diverse paths if the paths do not share any common nodes. In designing a network, providing node diverse paths between nodes provides a measure of protection in that, if any node fails for some reason (e.g., a particular node becomes too congested with data, etc.), then a node diverse path (i.e., a path that does not include the failed node) can remain unaffected and can be used in place of the path that includes the failed node. If, on the other hand, a non-node diverse fails between nodes, the nodes can become rendered incapable of communicating signals to or from each other.

In FIG. 3, the sub-net nodes 301, 302 and 303 are communicatively coupled via a plurality of paths that collectively form a virtual private network. In particular, the virtual private network in this example includes links 304, 305, 306, 307, 308, 309, 310, 311, 312, and 313. The virtual private network includes enough links to support three link diverse and node diverse paths between any two of the sub-net nodes 301, 302, and 303. For example, node 301 is connected to node 302 via three link diverse and node diverse paths, namely, a first path made up of links 304, 305 and 306; a second path made up of links 307 and 308; and a third path made up of links 309, 310, 311, and 313. In this way, if, for example, link 304 fails for some reason, then the first path is affected (i.e., non-operational), but the second and third paths remain unaffected (i.e., operational). If node 314 fails for some reason, then the second path is affected (i.e., non-operational), but the first and third paths remain unaffected (i.e., operational).

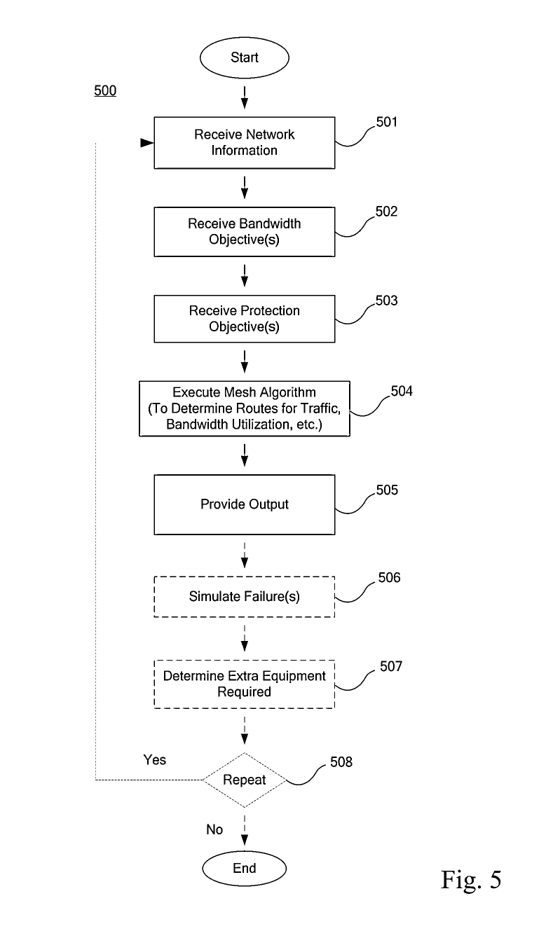

As will be described below in further detail in connection with FIG. 5, the procedure described herein, and/or the apparatus, system, and/or computer program that operate in accordance with the procedure, can, in some example embodiments, be used to design a network having a plurality of link diverse and/or node diverse paths to provide a measure of protection in the event of one or more link failures or node failures in the network.

Reference is now made to FIG. 4, which is an architecture diagram of an example data processing system 400, which can be used according to various aspects herein. In one example embodiment, data processing system 400 can be used to design, and/or simulate the performance of, a virtual private network such as networks 100, 200, and/or 300 described above. Data processing system 400 includes a processor 402 coupled to a memory 404 via system bus 406. Processor 402 is also coupled to external Input/Output (I/O) devices (not shown) via the system bus 406 and an I/O bus 408, and at least one input/output user interface 418. Processor 402 may be further coupled to a communications device 414 via a communications device controller 416 coupled to the I/O bus 408 and bus 406. Processor 402 uses the communications device 414 to communicate with other elements of a network, such as, for example, network nodes, and the device 414 may have one or more input and output ports. Processor 402 also can include an internal clock (not shown) to keep track of time, periodic time intervals, and the like.

A storage device 410 having a computer-readable medium is coupled to the processor 402 via a storage device controller 412 and the I/O bus 408 and the system bus 406. The storage device 410 is used by the processor 402 and controller 412 to store and read/write data 410a, as well as computer program instructions 410b used to implement the procedure(s) described herein and shown in the accompanying drawing(s) herein (and, in one example, to implement the functions represented in FIG. 5). The storage device 410 also can be used by the processor 402 and the controller 412 to store other types of data, such as, by example only, network information (see description of block 501 below), bandwidth objectives (see description of block 502 below), protection objectives (see description of block 503 below), simulation instructions (see description of block 506 below), and/or the like. In operation, processor 402 loads the program instructions 410b from the storage device 410 into the memory 404. Processor 402 then executes the loaded program instructions 410b to perform any of the example procedure(s) described herein, for operating the system 400.

Having described data processing system 400, an example network design procedure 500 according to an example embodiment herein will now be described with reference to FIG. 5. Data processing system 400, in one example, can be included in a network element management system and can implement the procedure 500 to design a virtual private network within an optical transport mesh network, although the procedure 500 can also be used for designing other types of networks as well.

At block 501, predetermined network information is received by the processor 402 (FIG. 4). The network information received by the processor 402 at block 501, as well as the various types of information (e.g., a bandwidth objective, a protection objective, a simulation instruction, etc.) that can be received by the processor 402 at each of blocks 502 through 508 (described below), may be received via, for example, the user interface 418 (e.g., inputted by a user), the storage device 410 (which may be preprogrammed to provide the various information to the processor 402), and/or one or more external devices by way of a network and the communications device 414. The term “network information”, as used herein, generally refers to information relating to the network that is being designed. Example network information that may be received by the processor 402 at block 501 includes, without limitation, a topology of a network (i.e., an arrangement of the various components (e.g., nodes, links) of a network), a geographical location of each node, a geographical location of each link, a length of each link, a statistical availability of each link and/or node (i.e., a statistically determined numerical probability that a particular link and/or node will be functional at any given point), a type of optical fiber used for each link, an optical signal to noise ratio of each link and/or node, one or more other optical characteristics of each link and/or node, an optical loss of each link and/or node, a polarization mode dispersion number of each link and/or node, one or more types of components included as part of a node, one or more routing capabilities (e.g., fast switching or slow switching) of each node, and/or any other information relating to each link, node, or any other network component.

At block 502, one or more predetermined bandwidth objectives are received by the processor 402. The term “bandwidth objective”, as used herein, generally refers to an amount of bandwidth (e.g., in gigabits per second) required for a particular type of traffic between particular nodes. For example, the processor 402 may receive a bandwidth objective indicating that 10 Gbps is required for a particular type of traffic between a particular pair of nodes.

At block 503, one or more predetermined protection objectives are received by the processor 402. The term “protection objective”, as used herein, generally refers to a number of mesh paths that may be deemed required, as well as a type of each mesh path, for a particular type of traffic between two particular nodes.

Example types of mesh paths include an active path, a protection path, and a restoration path. An active path is a default path (i.e., the paths used in the absence of any associated network failure) by which the particular type of traffic is communicated between the corresponding nodes. A protection path is an alternate path between the nodes which can be quickly switched into (by, e.g., one or more optical and/or electrical switches included at a particular node, not shown in FIG. 5) in the event of a failure of the associated active path. A restoration path is an alternate path between the nodes which can be switched into use, but may require more time to be switched into use than a protection path, in the event of a failure of the associated active path. In one example embodiment, whether a node is capable of supporting a protection path or a restoration path depends on the type of switch(es) (fast switches or slow switches) included in the node. A protection path may be required for important traffic and/or traffic that requires fast switching. For example, for telephone traffic, if an active path experiences a failure, the network should quickly (e.g., in less than 50 milliseconds) switch to an alternate path (i.e., a protection path) because otherwise the telephone call may be dropped. In contrast, for Internet traffic, if an active path experiences a failure, it may be sufficient for the network to switch to an alternate path (i.e., a restoration path) more slowly because there is no risk of dropping a telephone call.

Referring now back to block 503, the processor 402 may receive a protection objective indicating, for example, that three mesh paths are required for a particular type of traffic between a particular pair of nodes, with one mesh path being an active path, one being a protection path, and one being a restoration path, although this example combination of mesh paths is exemplary and should not be construed as limiting. In general, a protection objective can indicate the requirement of any combination of active, protection, and/or restoration paths. Additionally, in one example embodiment, the processor 402 can receive at block 503 a separate bandwidth amount for each mesh path. For example, the processor 402 can receive an active bandwidth of 10 Gbps for an active path, a protection bandwidth of 8 Gbps for a protection path, and a restoration bandwidth of 5 Gbps for a restoration path. In this example, only a portion (i.e., 8 Gbps) of the bandwidth of the active path is protected by the protection path, and an even smaller portion (i.e., 5 Gbps) of the bandwidth of the active path is protected by the restoration path. Additionally, as described in further detail below in connection with block 504 of FIG. 5, in one example embodiment, restoration paths can be shared among multiple pairs of nodes.

For purposes of illustration, Table 1 below provides an example representation of the various input parameters that can be provided as part of blocks 501 through 503, described above.

TABLE 1

| | | Bandwidth | | Type of |
|---|---|---|---|---|
| A_Loc | Z_Loc | (Gbps) | Mesh Paths | Mesh Path(s) |
| SUB-NET-1 | SUB-NET-2 | 3 | 3 | 1 active |
| | | | | 1 protection |
| | | | | 1 restoration |
| SUB-NET-1 | SUB-NET-2 | 1 | 2 | 1 active |
| | | | | 1 protection |
| SUB-NET-1 | SUB-NET-2 | 4 | 2 | 1 active |
| | | | | 1 protection |
| SUB-NET-1 | SUB-NET-2 | 0.4 | 3 | 1 active |
| | | | | 2 restoration |
| SUB-NET-1 | SUB-NET-2 | 2.2 | 1 | N/A |
| SUB-NET-3 | SUB-NET-2 | 2 | 3 | 1 active |
| | | | | 2 protection |
| SUB-NET-3 | SUB-NET-2 | 7 | 1 | N/A |
| SUB-NET-1 | SUB-NET-3 | 4 | 4 | 1 active |
| | | | | 2 protection |
| | | | | 1 restoration |
| SUB-NET-1 | SUB-NET-3 | 5 | 3 | 1 active |
| | | | | 1 protection |
| | | | | 1 restoration |
| SUB-NET-1 | SUB-NET-3 | 14 | 2 | 1 active |
| | | | | 1 protection |
| SUB-NET-1 | SUB-NET-3 | 3 | 2 | 1 active |
| | | | | 1 restoration |
| SUB-NET-1 | SUB-NET-3 | 12 | 1 | N/A |

Each row of Table 1 corresponds to a particular predetermined group of network traffic between a particular pair of nodes. The predetermined groups of traffic can be defined based on any number of factors, such as, by example only, a type of traffic. For example, the first five rows of Table 1 correspond to five different types of traffic, respectively, communicated between SUB-NET-1 and SUB-NET-2. Types of traffic may include, for example, telephone traffic, low priority Internet traffic (e.g., Internet traffic of a customer subscribed to a low tier Internet service), high priority Internet traffic (e.g., Internet traffic of a customer subscribed to a high tier Internet service), storage area network (SAN) traffic, etc. By enabling a user, such as, e.g., a communication service provider, to specify bandwidth and/or protection objectives of traffic based on the type of traffic, the procedure described herein enables the service provider to separately provision and monetize various distinct levels of service. Additionally, the service provider is enabled to mitigate costs of leasing the network from a network provider by using only additional mesh paths and/or additional protection equipment (switches, etc.) where necessary (e.g., for high tier traffic).

Table 1 indicates the various input parameters that can be provided as part of blocks 501 through 503, described above. In particular, the information in the first and second columns of Table 1 (designated A_Loc and Z_Loc, respectively), which can be provided as part of block 501, collectively represents a pair of nodes communicatively coupled via at least one path in the network. The information in columns three through five of Table 1 for a particular row indicate various objectives for the corresponding traffic communicated between the pair of nodes indicated in columns one and two of that row. In particular, for each type of traffic between each pair of nodes, the information in the third column of Table 1 (designated Bandwidth (Gbps)), which can be provided as part of block 502, indicates an amount of bandwidth (in gigabits per second) required for that type of traffic between that pair of nodes. Similarly, for each type of traffic between each pair of nodes, the fourth column of Table 1 (designated Mesh Paths), which can be provided as part of block 503, indicates a number of mesh paths required for that type of traffic between that pair of nodes. Finally, for each type of traffic between each pair of nodes, the fifth column of Table 1 (designated Type of Mesh Path(s)), which can be provided as part of block 503, indicates a type of each mesh path (e.g., an active path, a protection path, or a restoration path) for that type of traffic between that pair of nodes. For example, the first row of Table 1 indicates that, for a particular type of traffic between SUB-NET-1 and SUB-NET-2, 3 Gbps are required with three mesh paths including one active path, one protection path, and one restoration path.

Once the processor 402 has received the input parameters provided at blocks 501 through 503, the procedure progresses to block 504. At block 504, the processor 402 executes a mesh algorithm based on the network information, one or more bandwidth objective(s), and protection objective(s) received by the processor 402 at blocks 501, 502, and 503, respectively. The term “mesh algorithm”, as used herein generally refers to an algorithm for determining which routes to use to communicate specific types of traffic between the specific network nodes.

Exemplary mesh algorithms (e.g., example mesh algorithm(s) that may be executed at block 402) are described in, for example, the publication by J. Y. Yen, entitled “Finding the k Shortest Loopless Paths in a Network”, Management Science 17:712-716, 2 (hereinafter “the Yen publication”); the publication by E. Bouillet, G. Ellinas, J.-F. Labourdette, R. Ramamurthy, entitled “Path Routing in Mesh Optical Networks”, Wiley, 2007 (hereinafter “the Bouillet publication”); the publication by D. Eppstein, entitled “Finding the k Shortest Paths”, 35th IEEE Symp. Foundations of Comp. Sci., Santa Fe, 1994, pp. 154-165. Tech. Rep. 94-26, ICS, UCI, 1994. SIAM J. Computing 28(2):652-673, 1998 (hereinafter “the Eppstein publication”); and/or the publication by Ernesto Q. V. Martins and Marta M. B. Pascoal, entitled “A New Implementation of Yen's Ranking Loopless Paths Algorithm”, 4OR-Quarterly Journal of the Belgian, French and Italian Operations Research Societies, 2003 (hereinafter “the Martins publication”); although the mesh algorithm that may be executed at block 402 is not limited to these examples only. The Yen publication, the Bouillet publication, the Eppstein publication, and the Martins publication are hereby incorporated by reference in their entireties, as if set forth fully herein.

In general, the result of the mesh algorithm can include designated traffic routes and/or the bandwidth utilization for each of the routes. In particular, the mesh algorithm takes into account the network information, the one or more bandwidth objective(s), and the protection objective(s) received by the processor 402 at blocks 501, 502, and 503, respectively, to identify and designate specific routes (including, for example, the amount and configuration of active paths, protection paths, and/or restoration paths received by processor 402 at block 503), as well as bandwidth amounts of the designated routes (based on the bandwidth amount(s) received by processor 402 at block 502), to be used for communicating specific types of traffic between specific ones of the network nodes.

Since some network providers offer network bandwidth to customers in aggregate amounts for each link, in one example embodiment, the processor 402 computes, as part of the mesh algorithm, an aggregate amount of bandwidth required for all types of traffic for each link. That is, the processor 402 computes, for each link, a sum total of the bandwidth requirements of each type of traffic.

In one example embodiment, in order to efficiently allocate network links, the mesh algorithm executed by the processor 402 enables the sharing of a restoration path, such that a single path can be designated as the restoration path associated with a plurality of distinct active paths. This can result in fewer links being required for the overall network, thereby leading to a decreased cost of leasing the network from a network provider.

Referring now back to block 505, the processor 402 provides, via the user interface 418 (e.g., by providing a graphical image of the result via a display device), one or more results of the mesh algorithm executed at block 504. As mentioned above, the result of the mesh algorithm can include designated traffic routes and/or the bandwidth utilization for each of the routes.

In one example embodiment, the result of the mesh algorithm can include an indication of whether any link has been exhausted (i.e., has insufficient bandwidth to achieve the one or more bandwidth objective(s) received for that link by processor 402 at block 502). As described below in connection with block 508, in the event that one or more links has been exhausted, the procedure 500 may be repeated using different objectives in an effort to generate a network design that does not exhaust any links.

In another example embodiment, the procedure 500 ends after block 505. Alternatively, in other example embodiments, the procedure 500 can further include one or more of the functions associated with optional blocks 506, 507, and/or 508.

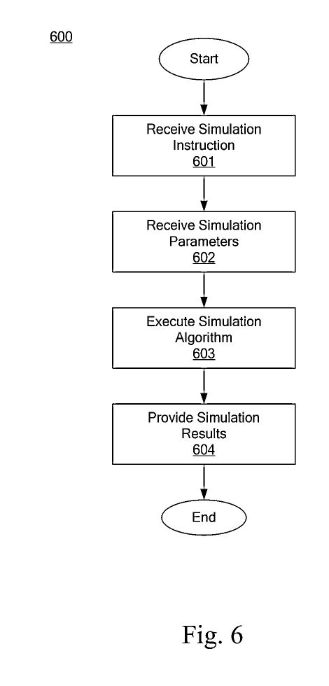

At optional block 506, the processor 402 executes a simulation of one or more failures. An example procedure 600 for simulating the failure of one or more links and/or nodes will now be described with reference to FIG. 6. In one example embodiment, the simulation procedure 600 may further represent the procedure of block 506 shown in FIG. 5.

At block 601, the processor 402 receives an instruction or command to initiate a simulation of one or more particular types of failures for one or more links. In one example embodiment, a user may utilize the user interface 418 to input the simulation instruction into the processor 402. Example types of failures that can be simulated by procedure 600 can include, for example and without limitation, a complete failure of one or more links (e.g., a fiber being physically severed), a complete failure of one or more nodes (e.g., a power outage at a particular node), a partial failure of one or more links (e.g., a fiber being partially damaged), and/or a partial failure of one or more nodes (e.g., a node becoming congested resulting in dropping a percentage of the data received at the node).

At block 602, one or more simulation parameters to be used for the simulation are received by the processor 402. The parameters received at block 602 may indicate, by example only and without limitation, which type of failure is to be simulated (e.g., a complete failure of one or more links, a complete failure of one or more nodes, a partial failure of one or more links, and/or a partial failure of one or more nodes), which link(s) and/or node(s) to simulate as having failed, a number of simultaneous failures (e.g., fiber cuts) to be simulated, and/or the like. In one example embodiment, a user may utilize the user interface 418 to input the simulation parameters into the processor 402. In another example embodiment, the processor 402 receives automated instructions 410b and/or simulation parameters from storage device 410 for simulating the partial or complete failure of one or more links and/or nodes.

At block 603, the processor 402 executes the simulation based on the simulation parameters received at block 601 and/or block 602. In one example embodiment, the processor 402 executes the simulation by designating as partially or completely failed the one or more links and/or nodes indicated in the received simulation parameters. The processor 402 then continues to execute the simulation by attempting to identify and re-route traffic from one or more failed paths to one or more available alternate paths (i.e., protection and/or restoration paths), which, in one example, have been previously defined as part of block 503 (FIG. 5), for the simulated failed link(s) and/or node(s). In another example embodiment, at block 603 the processor 402 iteratively simulates, optionally based at least in part on the simulation parameters received at block 601 and/or block 602, a predetermined plurality of link failures and/or node failures (e.g., all possible sets of N simultaneous link failures and/or node failures).

At block 604, the processor 402 provides, via the user interface 418 (e.g., by providing a graphical image of the result via a display device), one or more results of the simulation algorithm executed at block 603. In one example embodiment, the results provided by the processor 402 include an indication of whether the network survived the simulation (e.g., whether the processor 402 was able to successfully re-route at block 603 traffic from failed paths to available paths). In a case where the a predetermined plurality (e.g., N) link failures and/or node failures are iteratively simulated at block 603, the results provided by the processor 402 at block 604 may indicate whether the network has an ability to survive N simultaneous failures of links and/or nodes. In another example embodiment, the processor 402 can provide at block 604 a display identifying one or more links that have become exhausted upon activating the identified protection and/or restoration paths. Alternatively, the processor 402 can provide a display indicating that no links have become exhausted upon activating the identified protection and/or restoration paths. As described below in connection with block 508, in the event that the simulation indicates that one or more links has become exhausted, the procedure 500 (e.g., including another simulation at block 506) may be repeated using different objectives in an effort to generate a network design that does not exhaust any links.

In one example embodiment, as described above, in contrast to conventional network design techniques which often rely on conservative rules of thumb and guesswork in leasing equipment from a network provider, the procedures and systems described herein enable the simulation of one or more failures, thereby enabling a service provider to more accurately determine how much network equipment (how many links, nodes, bandwidth, etc.) to lease from a network provider. This can result in a decreased cost of leasing the network equipment from the network provider.

Referring again to FIG. 5, in one example embodiment, the procedure 500 ends after block 506. Alternatively, in other example embodiments, the procedure 500 can proceed to optional block 507. At optional block 507, the processor 402 determines whether any extra equipment is required to be added to the network in order to satisfy one or more of the one or more bandwidth objective(s), and the one or more protection objective(s) received by the processor 402 at blocks 502 and 503, respectively. For example, in the event that the processor 402, during the mesh algorithm of block 504, determines that it cannot provide a particular protection path requested at block 503 because one of the nodes of the path does not include a necessary switch, then the processor 402 can indicate that one or more optical, electrical, and/or opto-electrical switches must be installed at the particular node to enable it to support the protection path.

In one example embodiment, at block 507 the processor 402 computes, based at least in part on the network information provided at block 501 (described above), the OSNR for each link of the network and compares it to a predetermined threshold. An exemplary procedure for computing (e.g., at block 507) an OSNR is described in U.S. Patent Application Publication No. 2010/0322621 A1, which is hereby incorporated by reference in its entirety, as if set forth fully herein. If the processor 402 determines that a computed OSNR does not meet or exceed the predetermined threshold, the processor 402 provides, via the user interface 418, a result indicating that one or more signal-regenerating transponders are required to be installed at one or more particular locations in the network.

If the processor 402 determines that extra equipment is required, then the processor 402 provides, via the user interface 418 (e.g., by providing a graphical image of the result via a display device), information relating to any required extra equipment, for example, in the form of a bill of materials, installation instructions, and/or the like.

In one example embodiment, the procedure 500 ends after block 507. Alternatively, in other example embodiments, the procedure 500 can proceed to optional block 508. At optional block 508, the processor 402 requests, via the user interface 418, whether a user desires to repeat the procedure 500. If the processor 402 receives, via the user interface 418, an indication that the user desires to repeat the procedure 500 (perhaps with different input parameters with the goal of achieving a different result) then the procedure 500 described above can be repeated. According to one example, the procedure 500 may be repeated using a greater number (e.g., N) of simulated link failures (e.g., fiber cuts) and/or node failures than was used during a previous iteration of the procedure 500, to determine whether the network is able to survive N-simultaneous link failures and/or node failures (N-failure survivability). In one example, the processor 402 may generate a list of extra equipment (if any) determined (at block 507) to be required in order to enable the network to achieve N-failure survivability. The processor 402 may then compute, based on the generated list, a total cost of the extra equipment, which represents an estimated cost of improving the reliability of the network to N-failure survivability.

The example aspects herein provide a procedure, as well as an apparatus, system, and computer program that operate in accordance with the procedure enabling a user (e.g., a communication service provider) to design a communications network, specifying bandwidth and/or protection objectives of traffic based on the type of traffic, and separately provisioning and monetizing various distinct levels of service.

Additionally, the service provider is enabled to mitigate costs of leasing the network from a network provider by using only additional mesh paths and/or additional protection equipment (switches, etc.) where necessary (e.g., for high tier traffic).

It should be noted that the network configurations represented in FIGS. 1 through 3 are merely illustrative in nature, and should not be construed as being limiting to the scope of the invention. Also, in other embodiments, the networks may have other configurations than those shown in FIGS. 1 through 3.

The devices and/or servers described herein may be, in one non-limiting example, a computer or farm of computers that facilitate the transmission, storage, and reception of information and other data between different points. From a hardware standpoint, in one example a server computer will typically include one or more components, such as one or more microprocessors (also referred to as “controllers”) (not shown), for performing the arithmetic and/or logical operations required for program execution. Also in one example, a server computer will also typically include disk storage media (also referred to as a “memory”), such as one or more disk drives for program and data storage, and a random access memory, for temporary data and program instruction storage. From a software standpoint, in one example a server computer also contains server software resident on the disk storage media, which, when executed, directs the server computer in performing its data transmission and reception functions. As is well known in the art, server computers are offered by a variety of hardware vendors, can run different operating systems, and can contain different types of server software, each type devoted to a different function, such as handling and managing data from a particular source, or transforming data from one format into another format.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine-accessible, computer-readable, and/or machine-readable medium (memory) having instructions. The instructions on the machine-accessible, computer-readable and/or machine-readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium”, “computer-readable medium”, “machine-readable medium”, or “memory” used herein shall include any medium that is capable of storing, encoding, or transmitting a sequence of instructions for execution by the machine and that cause the machine to perform any one of the procedures described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs. Indeed, the numbered parts of the above-identified procedures represented in the drawings may be representative of operations performed by one or more respective modules, wherein each module may include software, hardware, or a combination thereof.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects herein have been described in certain specific example embodiments, many additional modifications and variations would be apparent to those skilled in the art. It is therefore to be understood that the various example embodiments herein may be practiced otherwise than as specifically described. Thus, the present example embodiments, again, should be considered in all respects as illustrative and not restrictive.

What is claimed is:

1. A procedure for designing a virtual private network, the procedure comprising:
providing at least one of network information, a bandwidth objective and a protection objective; and
executing a mesh algorithm based on the at least one of the network information, the bandwidth objective and the protection objective, to generate one or more mesh algorithm results.

2. The procedure of claim 1, the procedure further comprising:
executing a simulation of at least one of a link failure and a node failure, to generate one or more simulation results.

3. The procedure of claim 2, wherein the link failure includes at least one of a partial failure of a link and a complete failure of a link, and the node failure includes at least one of a partial failure of a node and a complete failure of a node.

4. The procedure of claim 2, further comprising providing the one or more simulation results via a graphical user interface.

5. The procedure of claim 1, the procedure further comprising:
identifying additional network equipment required based on the at least one of the network information, the bandwidth objective and the protection objective; and
providing a bill of materials associated with the additional network equipment.

6. The procedure of claim 5, wherein the providing the bill of materials further comprises providing a bill of materials via a graphical user interface.

7. The procedure of claim 5, wherein the additional network equipment includes at least one of one or more optical, electrical, and/or opto-electrical switches of a node and signal regenerating transponders.

8. The procedure of claim 1, wherein the protection objective indicates, for a predetermined type of traffic between nodes, at least one of a number of mesh paths required and a type of one or more mesh paths.

9. The procedure of claim 8, wherein the type of one or more mesh paths includes at least one of an active path, a protection path, and a restoration path.

10. The procedure of claim 1, wherein the providing the one or more mesh algorithm results further comprises providing the one or more mesh algorithm results via a graphical user interface.

11. The procedure of claim 1, wherein the one or more mesh algorithm results includes an indication of whether a link has been exhausted.

12. The procedure of claim 1, wherein the network information includes at least one of a topology of the network, a geographical location of a node, a geographical location of a link, a length of a link, a statistical availability of a link, a statistical availability of a node, a type of optical fiber used for a link, an optical signal to noise ratio (OSNR), an optical loss of a link, an optical loss of a node, a polarization mode dispersion number of a link, a polarization mode dispersion number of a node, a node component, and a node routing capability of a node.

13. The procedure of claim 1, wherein the bandwidth objective indicates an amount of bandwidth required for a predetermined type of traffic between nodes.

14. A system comprising:
at least one apparatus arranged to:
provide at least one of network information, a bandwidth objective and a protection objective; and
execute a mesh algorithm based on the at least one of the network information, the bandwidth objective and the protection objective, to generate one or more mesh algorithm results.

15. The system of claim 14, the at least one apparatus being further arranged to:
execute a simulation of at least one of a link failure and a node failure, to generate one or more simulation results.

16. The system of claim 14, the at least one apparatus being further arranged to:
identify additional network equipment required based on the at least one of the network information, the bandwidth objective and the protection objective; and
provide a bill of materials associated with the additional network equipment.

17. The system of claim 14, wherein the protection objective indicates, for a predetermined type of traffic between nodes, at least one of a number of mesh paths required and a type of one or more mesh paths.

18. The system of claim 17, wherein the type of one or more mesh paths includes at least one of an active path, a protection path, and a restoration path.

19. An apparatus comprising:
at least one communication interface, arranged to provide at least one of network information, a bandwidth objective and a protection objective; and
at least one processor coupled to the at least one communication interface, and arranged to execute a mesh algorithm based on the at least one of the network information, the bandwidth objective and the protection objective, to generate one or more mesh algorithm results.

20. The system of claim 19, wherein the at least one processor is further arranged to execute a simulation of at least one of a link failure and a node failure, to generate one or more simulation results.

21. The system of claim 19, wherein the at least one processor is further arranged to identify additional network equipment required based on the at least one of the network information, the bandwidth objective and the protection objective.
